(19) United States
(12) Patent Application Publication
(10) Pub. No.: US 2020/0124925 A1
(43) Pub. Date: Apr. 23, 2020

(54) ARRAY SUBSTRATE, AND DISPLAY DEVICE

(71) Applicant: HKC Corporation Limited, Shenzhen (CN)

(72) Inventor: Min Li, Shenzhen (CN)

(21) Appl. No.: 16/245,273

(22) Filed: Jan. 11, 2019

Related U.S. Application Data
(63) Continuation of application No. PCT/CN2018/119048, filed on Dec. 4, 2018.

(30) Foreign Application Priority Data
Oct. 23, 2018 (CN) 201811238407.2

(51) Int. Cl. G02F 1/1343; G02F 1/137

(52) U.S. Cl. CPC G02F 1/134309; G02F 1/136286; G02F 1/137; G02F 1/13439

(57) ABSTRACT

The present disclosure provides an array substrate and a display device, the array substrate includes a substrate, a plurality of scan lines and data lines, a first insulating layer, a pixel electrode, a second insulating layer, and at least one auxiliary electrode which are arranged in sequence, the scan lines cross data lines to form a plurality of pixel regions, and each pixel region defines a switch member electrically connected with the data lines and the scan lines. The pixel electrode electrically connects with the switch member and has a plurality of branches arranged in parallel and spaced from each other, and an angle is defined between the branch and the scan line or between the branch and the data line. The auxiliary electrode is defined on the second insulating layer and electrically contacts with the pixel electrode.

### CROSS-REFERENCE TO RELATED PRESENT DISCLOSURES

The present disclosure is a Continuation Application of PCT Application No. PCT/CN2018/119048, filed on Dec. 4, 2018, which claims the benefit of China Patent Application No. 2018112384072, filed Oct. 23, 2018, with the State Intellectual Property Office and entitled “array substrate, and display device”, the entirety of which is hereby incorporated herein by reference.

### TECHNICAL FIELD

The present disclosure generally relates to the technical field of display, and more particularly relates to an array substrate, and a display device

### BACKGROUND

The statements herein merely provide background information related to the present disclosure and do not necessarily constitute prior Art. Due to the advantages of high contrast, wide view angle, low power consumption, and fast response speed, polymer stabilized vertical aligned (PSVA) liquid crystal technology is widely used in the manufacturing industry of liquid crystal display panel. The display panel includes an array substrate, a color substrate, and a liquid crystal layer sandwiched between the array substrate and the color substrate. A certain proportion of phototropic monomers are added to the liquid crystal used in the PSVA process. Under the action of an applied electric field, the phototropic monomers gather on surfaces of the array substrate and the color substrate with a certain pretilt angle. At this time, if ultraviolet ray (UV) is applied to the array substrate side, these phototropic monomers may solidify to form a polymer network and maintain the original pretilt angle even if the applied voltage is removed.

Currently, in PSVA technology, the conductive layers on the array substrate side all have a plurality of branches to control the rotation of liquid crystal molecules to form different domains, so as to obtain higher light transmittance. However, the effect of driving liquid crystal molecules by the conductive layers of the current array substrate is not good, so that the display effect of the display panel is poor.

### SUMMARY

It is therefore one main object of the disclosure to provide an array substrate, which aims to improve the light transmittance of display panel and improve the display effect.

In order to realize the above aim, the array substrate provided by the present disclosure includes:

a substrate;

a plurality of scan lines and data lines, covering the substrate, the scan lines and data lines crossing with each other to form a plurality of pixel regions, each pixel region defining a switch member electrically connected with the data line and scan line;

a first insulating layer, covering the scan line, the data line, and the switch member;

a pixel electrode, covering the first insulating layer and electrically connecting to the switch member, the pixel electrode comprising a plurality of branches arranged in parallel and spaced from each other, an angle being defined between the branch and the scan line, or between the branch and the data line;

a second insulating layer, covering the pixel electrode; and

at least one auxiliary electrode, defined on the second insulating layer and electrically contacted with the pixel electrode.

In some embodiments of the present disclosure, the auxiliary electrode comprises a power receiving part and a reinforcing part connected to the power receiving part, the reinforcing part attaches to a surface of the second insulating layer, the second insulating layer defines a through hole, and the power receiving part extends into the through hole and connects to the pixel electrode.

In some embodiments of the present disclosure, the middle portion of the reinforcing part bends downwards to form the power receiving part, and the power receiving part comprises a contact surface abutting the pixel electrode.

In some embodiments of the present disclosure, there are a plurality of auxiliary electrodes, the plurality of auxiliary electrodes are arranged in array and spaced from each other.

In some embodiments of the present disclosure, the shape of a projection of the auxiliary electrode on the second insulating layer is rectangle, foursquare, or circle.

In some embodiments of the present disclosure, the pixel electrode comprises a main body, and the branch connects to the periphery of the main body.

In some embodiments of the present disclosure, the main body has a cross shape, and the plurality of branches are radially arranged around the center of the main body.

In some embodiments of the present disclosure, the array substrate further includes an alignment film, the alignment film covers the auxiliary electrode.

The present disclosure further provides an array substrate, which includes a substrate;

a plurality of scan lines and data lines, covering the substrate, the scan lines and data lines crossing with each other to form a plurality of pixel regions, each pixel region defining a switch member electrically connected with the data line and scan line;

a first insulating layer, covering the scan line, the data line, and the switch member;

a pixel electrode, covering the first insulating layer and electrically connecting to the switch member, the pixel electrode comprising a plurality of branches arranged in parallel and spaced from each other, an angle being defined between the branch and the scan line, or between the branch and the data line;

a second insulating layer, covering the pixel electrode; and

a plurality of auxiliary electrodes, defined on the second insulating layer and electrically contacted with the pixel electrode, the shape of a projection of the auxiliary electrode on the second insulating layer being rectangle, foursquare, or circle.

The present disclosure further provides a display device, which includes a display panel and a backlight assembly connected to the display panel, the display panel comprising an array substrate and a color substrate facing the array substrate, the array substrate comprising:

a substrate;

a plurality of scan lines and data lines, covering the substrate, the scan lines and data lines crossing with each other to form a plurality of pixel regions, each pixel region defining a switch member electrically connected with the data line and scan line;

a first insulating layer, covering the scan line, the data line, and the switch member;

a pixel electrode, covering the first insulating layer and electrically connecting to the switch member, the pixel electrode comprising a plurality of branches arranged in parallel and spaced from each other, an angle being defined between the branch and the scan line, or between the branch and the data line;

a second insulating layer, covering the pixel electrode; and

at least one auxiliary electrode, defined on the second insulating layer and electrically contacted with the pixel electrode.

In the technical solution of the present disclosure, the data lines and scan lines defined on the array substrate divide the array substrate into a plurality of pixel regions, and each pixel region defines a switch member so as to realize independent control of each pixel region. The first insulating layer and the second insulating layer both protect adjacent conductive members from interference. The pixel electrode has a plurality of branches arranged in parallel and spaced from each other, and one angle is defined between the branch and the scan line, or between the branch and the data line. Under the action of the electric field, the branches can drive the liquid crystal molecules to rotate along the incline direction, so that light can pass through and image display is realized. At the same time, the auxiliary electrode electrically connected with the pixel electrode is also arranged on the surface of the second insulating layer. When the display panel is powered on, the auxiliary electrode can enhance the electric field strength of the display panel and enable more liquid crystal molecules to rotate at the same incline angle as the branches, thereby increasing the quantity of imaged liquid crystals, and improving the light transmittance, further improving the brightness and view angle of the display panel composed of the array substrate, and the display effect and quality are improved.

### BRIEF DESCRIPTION OF THE DRAWINGS

To better illustrate the technical solutions that are reflected in various embodiments according to this disclosure or that are found in the prior art, the accompanying drawings intended for the description of the embodiments herein or for the prior art will now be briefly described, it is evident that the accompanying drawings listed in the following description show merely some embodiments according to this disclosure, and that those having ordinary skill in the art will be able to obtain other drawings based on the arrangements shown in these drawings without making inventive efforts.

FIG. 1 is a structural diagram of one pixel region of the array substrate of the present disclosure in some embodiments;

FIG. 2 is a structural diagram of one pixel region of the array substrate of the present disclosure in another embodiments;

FIG. 3 is a cross-sectional diagram of a portion of the display panel including the array substrate of the present disclosure;

FIG. 4 is a cross-sectional diagram of the display panel shown in FIG. 3 under an applied voltage;

FIG. 5 is a cross-sectional diagram of another portion of the display panel of the present disclosure when the voltage and ultraviolet light are applied;

FIG. 6 is a cross-sectional diagram of a further portion of the display panel of the present disclosure when the voltage and ultraviolet light are applied;

FIG. 7 is a cross-sectional diagram of the display panel shown in FIG. 3 when the voltage is removed;

FIG. 8 is a cross-sectional diagram of the display panel shown in FIG. 5 when the voltage is removed;

FIG. 9 is a cross-sectional diagram of the display panel shown in FIG. 6 when the voltage is removed.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, all of the directional instructions in the exemplary embodiments of the present disclosure (such as top, down, left, right, front, back . . . ) can only be used for explaining relative position relations, moving condition of the members under a special form (referring to figures), and so on, if the special form changes, the directional instructions changes accordingly.

It should be further noted that in depictions of the present disclosure, terms such as “connect” should be understood in a broad sense, unless otherwise prescribed or defined explicitly. In other words, the connection can be a fixed connection, a removable connection or an integral connection. Of course, the connection can also be a direct connection, an indirect connection via an intermediary, or an internal communication between two members. For a person having ordinary skills in the art, he/she can understand specific meanings of the above terms in the present disclosure upon specific situations.

In addition, the descriptions, such as the “first”, the “second” in the exemplary embodiment of present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

The present disclosure provides an array substrate 1 (such as a thin film transistor substrate, a thin film transmitter (TFT)).

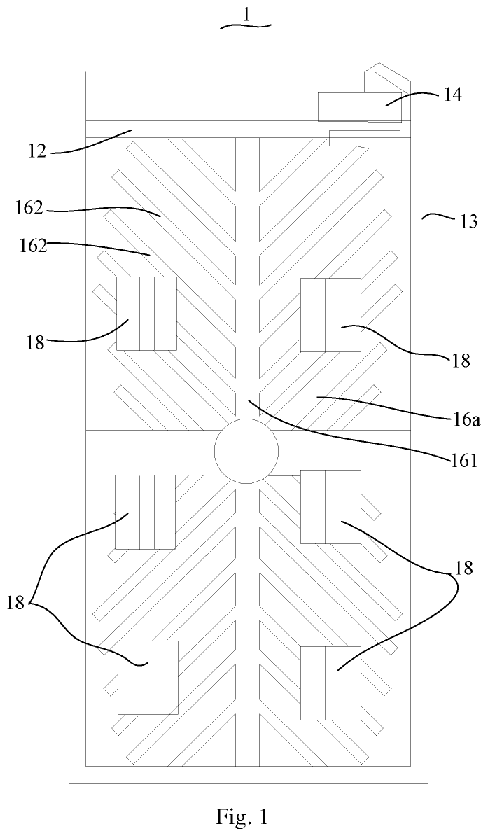

Referring to FIGS. 1 to 3, in some embodiments of the present disclosure, the array substrate 1 includes:

a substrate 11,

a plurality of scan lines 12 and data lines 13 covering the substrate 11, the scan lines 12 and data lines 13 cross each other to define a plurality of pixel regions, each pixel region is provided with a switch member 14 electrically connected to the data lines 13 and the scan lines 12;

a first insulating layer 15, covering the scan line 12, the data line 13, and the switch member 14;

a pixel electrode 16, covering the first insulating layer 15 and electrically connecting to the switch member 14, the pixel electrode 16 includes a plurality of branches 162 arranged in parallel and spaced from each other, an angle is defined between the branch 162 and the scan line 12, or between the branch 162 and the data line 13;

a second insulating layer 17, covering the pixel electrode 16; and

at least one auxiliary electrode 18, defined on the second insulating layer 17 and electrically contacted with the pixel electrode 16.

In some embodiments, the substrate 11 is also made of a transparent glass plate, which does not affect the passage of the backlight and provides a basic carrier, but the substrate 11 is not conductive. Since the movement and arrangement of the liquid crystal molecules 31 need electrons to drive, the liquid crystal carrier glass needs a conductive part to control the movement of the liquid crystal. Therefore, the data line 13, the scan line 12, the switch member 14, the first insulating layer 15, the pixel electrode 16, the second insulating layer 17, and the auxiliary electrode 18 are sequentially defined on the substrate 11, and the above components are sequentially defined on the substrate 11 through coating, exposure, development, and etching processes to ensure the structure stability. The data line 13 receives a data signal from a data drive circuit, and transmits the content to be displayed, and the scan line 12 writes the data signal to the pixel electrode 16 and supplies the switch member 14 with an on-off voltage. The first insulating layer 15 and the second insulating layer 17 may be made of a non-conductive resin material, and play a role of avoiding interference between adjacent conductive members.

The data line 13 and the scan line 12 are both made of opaque non-ferrous metal material, and the data lines 13 vertically cross the scan lines 12 to form a plurality of pixel regions, each pixel region is provided with the switch member 14 and the pixel electrode 16, the switch member 14 is a TFT switch, specifically a TFT thin film transistor, the thin film transistor includes a drain electrode, a source electrode, and a gate electrode, and controls the opening and closing of each pixel region. The pixel region includes a light-transmitting area and an opaque light-shielding area, the switch member 14 is in the light-shielding area, the pixel electrode 16 is in the light-transmitting area, and the light-shielding area corresponds to the black matrix of the color substrate 2.

The pixel electrode 16 of some embodiments is transparent conductive metal, such as indium tin oxide (ITO), ITO does not block the passage of light, and ITO has a pattern of a plurality of branches 162 arranged in parallel and spaced from each other. An angle is defined between the branch 162 and the scan line 12 or between the branch 162 and the data line 13, for example, the angle is 45 degrees, and the electrodes of the plurality of branches 162 are densely arranged. Under the action of electric field, the branches 162 can drive the liquid crystal molecules 31 to rotate along the incline direction, so that the liquid crystal molecules 31 can be inclined at 45 degrees, and the maximum light transmittance can be achieved at this time, and a high-quality display effect can be achieved. The auxiliary electrode 18 may be made of the same material as the pixel electrode 16 to generate a more uniform driving force.

In the technical solution of the present disclosure, the data lines 13 and the scan lines 12 defined on the array substrate 1 divide the array substrate 1 into a plurality of pixel regions, and each pixel region defines a switch member 14, thereby realizing independent control of each pixel region. And, at least one auxiliary electrode 18 electrically connected to the pixel electrode 16 is also provided on the surface of the second insulating layer 17 in each pixel region. When the display panel 100 is powered on, the auxiliary electrode 18 can enhance the electric field strength of the display panel 100, enabling more liquid crystal molecules 31 to rotate at the same incline angle as the branches 162, thereby increasing the quantity of imaged liquid crystals, and improving the light transmittance, further improving the brightness and view angle of the display panel 100, such the display effect and quality are effectively improved.

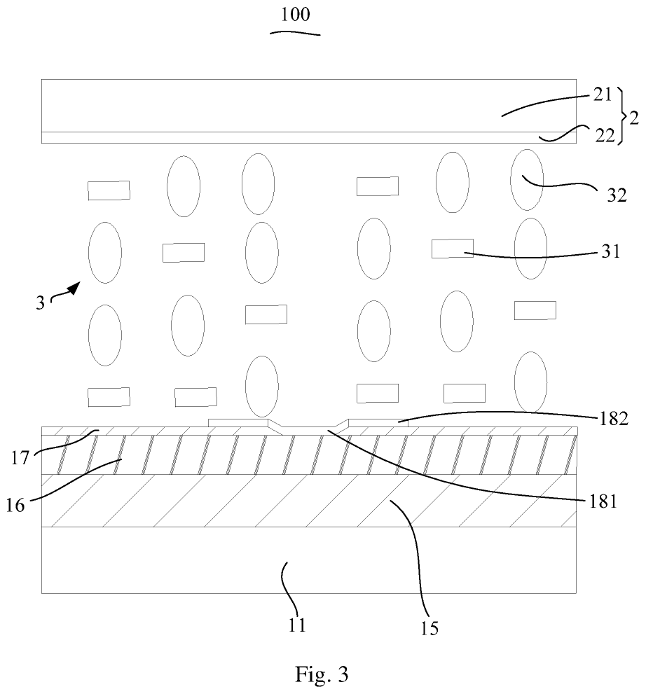

Please referring to FIG. 3, the auxiliary electrode 18 includes a power receiving part 181 and a reinforcing part 182 connected to the power receiving part 181, the reinforcing part 182 is attached to the surface of the second insulating layer 17, the second insulating layer 17 is provided with a through hole, and the power receiving part 181 extends into the through hole and connects to the pixel electrode 16.

In some embodiments, the reinforcing part 182 may be integrally formed with the power receiving part 181 or may be fixedly connected with the power receiving part 181. The electrical connection between the auxiliary electrode 18 and the pixel electrode 16 is realized through the power receiving part 181, the power receiving part 181 may be plate shaped, rod shaped, or line shaped, and the second insulating layer 17 is provided with the through hole that matches the power receiving part 181 in shape to realize stable connection. The reinforcing part 182 is attached to the surface of the second insulating layer 17 and closer to the liquid crystal molecules 31. After conducting electricity through the power receiving part 181, a new potential difference can be formed between the reinforcing part 182 and the color substrate 2 to generate electric field, which enhances the electric field strength, thereby increasing the driving force to the liquid crystal molecules 31, so that the liquid crystal molecules 31 located in the middle of the array substrate 1 and the color substrate 2 can also be tilted, thereby increasing the quantity of imaged liquid crystal molecules 31, and improving the light transmittance, such the display quality and brightness are improved.

In one embodiment of the present disclosure, the middle portion of the reinforcing part 182 bends downwards to form the power receiving part 181, and the power receiving part 181 includes a contact surface abutting the pixel electrode 16.

In some embodiments, the power receiving part 181 is located at the middle of the reinforcing part 182 and is formed by recessing the reinforcing part 182. The integrated structure can improve the conductivity of the internal current of the auxiliary electrode 18, thereby enabling the auxiliary electrode 18 to react more quickly and drive the liquid crystal molecules 31 more quickly. Of course, the power receiving part 181 may be provided on one side of the reinforcing part 182 and formed by bending one end of the reinforcing part 182 directly. The reinforcing part 182 has a certain width, so the power receiving part 181 has a contact surface for abutting the pixel electrode 16, so that stable contact can be realized and stable power supply can be provided to the auxiliary electrode 18, thereby driving the liquid crystal molecules 31 more permanently and stably, and avoiding insufficient driving force after power failure, and the display stability of the display panel 100 is ensured.

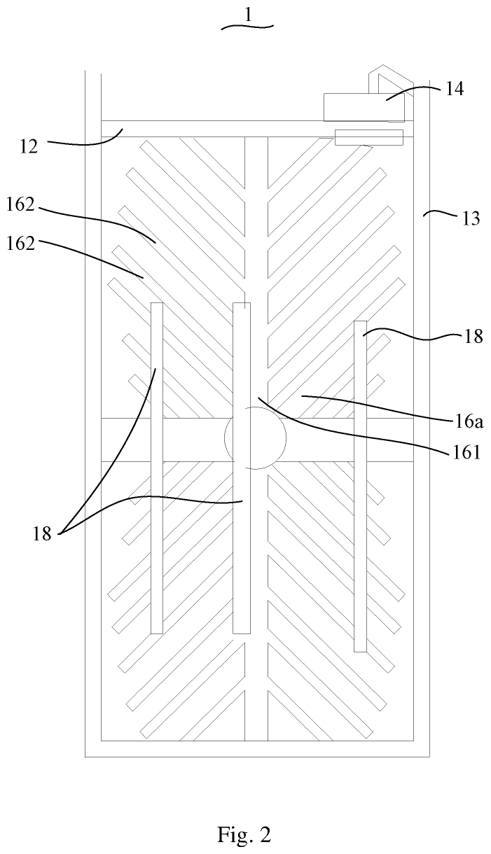

Referring again to FIGS. 1 and 2, in some embodiments of the present disclosure, there are a plurality of auxiliary electrodes 18 which are arranged in parallel and spaced from each other.

In order to further improve the driving of the liquid crystal molecules 31 to incline, there are a plurality of auxiliary electrodes 18 to further increase the electric field strength, thereby enabling more liquid crystal molecules 31 to incline, thus the light transmittance is further improved, and the brightness is higher. Specifically, the quantity of auxiliary electrodes 18 can be set in the range of 3 to 20, which can have a good display effect and ensure the processing cost. The plurality of auxiliary electrodes 18 are arranged in an array manner and spaced from each other, so that the electric field formed between the auxiliary electrodes 18 and the color substrate 2 can be more uniform, and the driving force distribution for the liquid crystal layer 3 between the two substrates can be more uniform, so that the rotation of the liquid crystal molecules 31 at each position can be more uniform, thereby improving the light transmittance and increasing the view angle.

In some embodiments of the present disclosure, the shape of a projection of the auxiliary electrode 18 on the second insulating layer 17 is rectangle, foursquare, or circle. The auxiliary electrode 18 can be provided with a relatively simple structure and shape in order to manufacture the auxiliary electrode 18 conveniently. Of course, the shape of the projection of the auxiliary electrode 18 on the second insulating layer 17 may also be a polygon.

Referring to FIGS. 1 and 2, the pixel electrode 16 includes a main body 161, and the plurality of branches 162 are connected to the periphery of the main body 161 at parallel intervals. In some embodiments, the main body 161 and the branches 162 of the pixel electrode 16 are made of the same material, and the pixel electrode 16 has an integral structure and is generally fish-bone shaped, thus improving the conduction stability of the pixel electrode 16. The plurality of branches 162 are arranged in parallel and spaced from each other, so that the inclining directions of the liquid crystal molecules 31 are also consistent, thereby ensuring the transmittance of light. Specifically, in some embodiments of the present disclosure, the main body 161 has a cross shape, and the plurality of branches 162 are radially arranged around the center of the main body 161. The cross-shaped main body 161 can be divided into four regions, which includes an upper region, a lower region, a left region, and a right region, and the plurality of branches 162 are respectively arranged in a 45 degrees direction with respect to a circumference of the main body 161 in the four regions, and the branches 162 in the adjacent two regions are mirrored, thereby increasing the inclining direction of the liquid crystal molecules 31, so as to obtain higher light transmittance.

In order to further increase the inclining rate of liquid crystal molecules 31, in some embodiments of the present disclosure, the array substrate 1 further includes an alignment film, the alignment film covers the auxiliary electrode 18.

The alignment film is made of polyimide. When the alignment film is made, the liquid material is coated on the surfaces of the array substrate 1 and the color substrate 2, and can provide anchoring energy for the liquid crystal after being cured twice.

The present disclosure also relates to a display panel 100 including the array substrate 1 described above, the display panel 100 may be a liquid crystal display panel 100. As can be understood, the display panel 100 includes an array substrate 1 and a color filter (CF) facing the array substrate 1, and a liquid crystal layer 3 sandwiched by the array substrate 1 and the color substrate 2. The array substrate 1 and the color substrate 2 form a sealed space through a sealing frame, and the liquid crystal layer 3 is located in the sealed space. The liquid crystal layer 3 of the present disclosure includes liquid crystal molecules 31 and phototropic monomers 32, the liquid crystal molecules 31 and the phototropic monomers 32 are mixed and filled in the sealed space.

The color substrate 2 is composed of a glass substrate 21, a shielding layer, a color layer, a protective film, and a conductive film. In the TFT liquid crystal display, the glass substrate 21 needs to use alkali-free glass. The shielding layer is an anti-reflection black matrix made on the glass substrate 21 to prevent light leakage between pixels and increase color contrast. Currently, the shielding layer is normally made of resin materials. The color layer mainly uses the color photoresist as the filter film, and its components include high transparency and high heat resistance polymer resin binder, and dye or pigment colorant, so that the transparent polymer resin has color and generally needs to have the characteristics of light resistance, good heat resistance, high color saturation and good penetrability, etc. The purpose of the protective film is to protect the color filter layer and increase the smoothness of the surface. The conductive film, that is, the common electrode 22, is arranged to form a potential difference with the pixel electrode 16 of the array substrate 1 to drive the liquid crystal molecules 31.

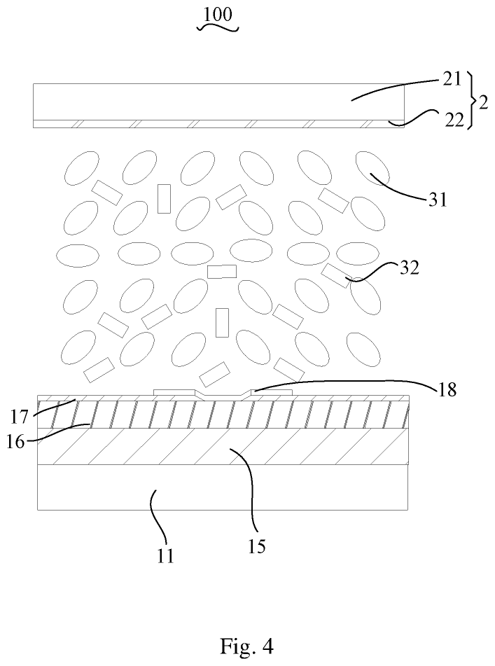

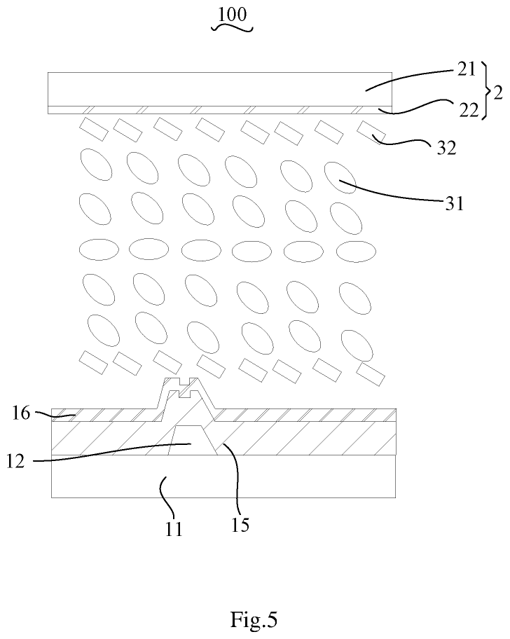

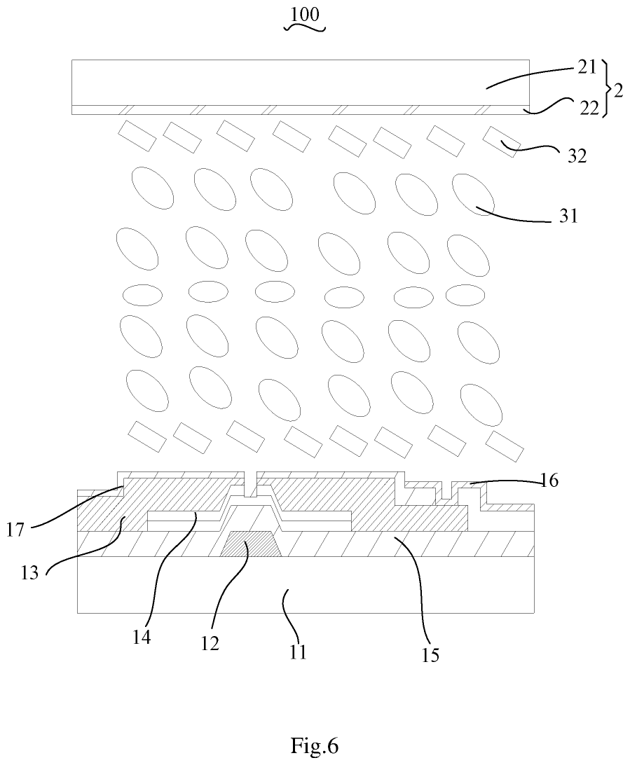

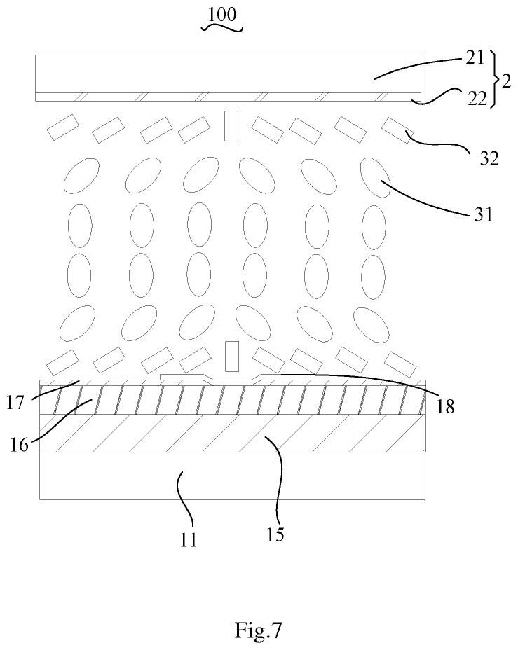

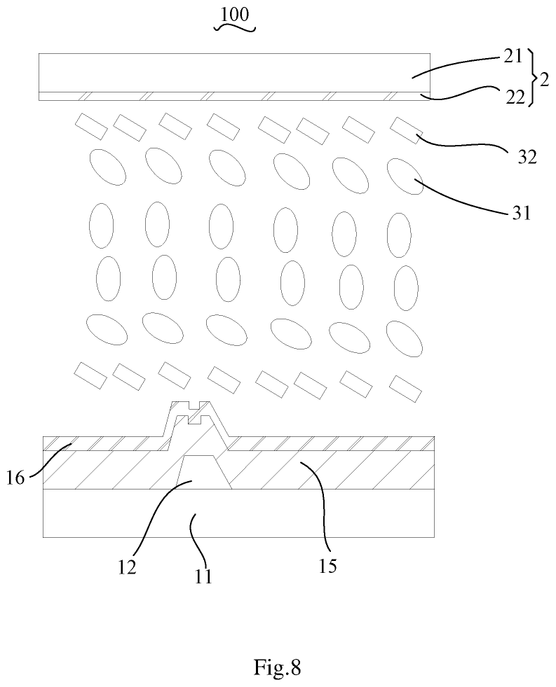

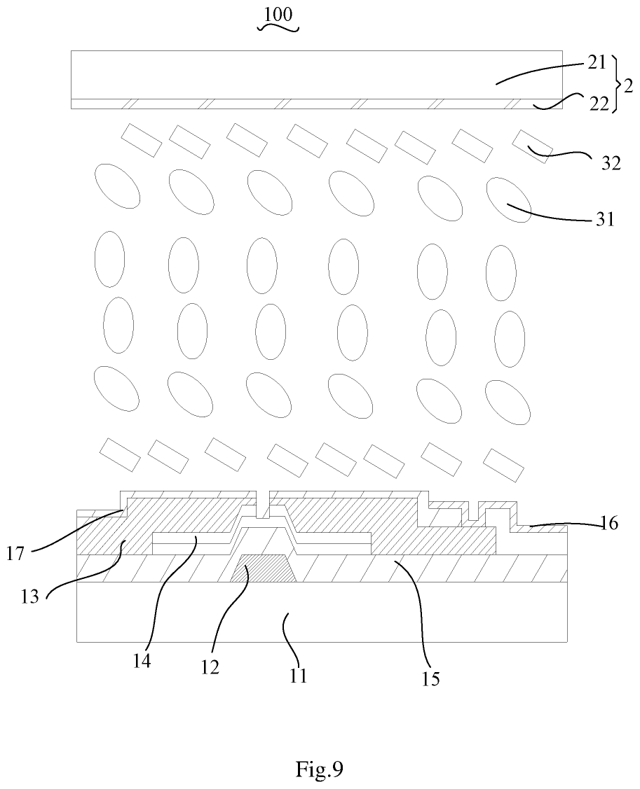

Referring to FIGS. 3 to 9, when no voltage is applied to the display panel 100 which has not been subjected to photo-alignment treatment after being assembled shown in FIG. 3, the liquid crystal molecules 31 and phototropic monomers 32 located between the array substrate 1 and the color substrate 2 are freely dispersed, and the liquid crystal molecules 31 are all in a vertical state. In the light alignment process, when a voltage is applied to the display panel 100, as shown in FIG. 4, the liquid crystal molecules 31 are inclined along the angle of the branch 162 of the pixel electrode 16, and the liquid crystal molecules 31 located in the middle can also be inclined due to the presence of the auxiliary electrode 18, and the directions in which the liquid crystal molecules 31 are inclined also increase, the liquid crystal molecules 31 located at the edge are inclined in one direction, and the phototropic monomer 32 is still freely dispersed. As shown in FIG. 5 and FIG. 6, when UV light is applied to the array substrate 1, the light power range at this time can be 50 mW to 5000 mW, and the light time can be 10 seconds to 500 seconds , the phototactic monomers 32 are polymerized into a polymer compound to attract the liquid crystal molecules 31 in surface layer to form a fixed pre-incline angle. As shown in FIG. 7, FIG. 8, and FIG. 9, after UV illumination is finished, the applied voltage is removed, the liquid crystal molecules 31 of the array substrate 1 and the color substrate 2, in surface layer, still maintain a pre-incline angle alignment, and the liquid crystal molecules 31 in the intermediate layer return to a vertical alignment.

The display panel 100 is also provided with a first polarizer and a second polarizer on the lower surface of the array substrate 1 and the upper surface of the color substrate 2, the polarization directions of the two polarizers are vertical, and the light from the backlight first passes through the first polarizer to become linearly polarized light, the polarization direction is consistent with the polarization axis direction of the first polarizer, and when passing through the liquid crystal layer 3, the linearly polarized light becomes elliptically polarized light or circularly polarized light due to the birefringence of the liquid crystal molecules 31, and when the elliptically polarized light or circularly polarized light passing through the upper polarizer, the light consistent with the polarization axis direction passes through the upper polarizer to realize picture display.

The display panel of the embodiments of the present disclosure may also be any of the following: OLED display panel, QLED display panel, twisted nematic (TN), or super twisted nematic (STN) type, in-plane switching (IPS) type, vertical alignment (VA) type, curved panel, or other display panels.

The present disclosure also provides a display device including the display panel 100 as described above and a backlight assembly connected to the display panel 100. The specific structure of the display panel 100 refers to the above embodiments. As the display device adopts all the technical proposals of the above exemplary embodiments, the display device at least has all of the beneficial effects of the technical proposals of the above exemplary embodiments, no need to repeat again.

In some embodiments, the backlight assembly is arranged near the lower polarizer, and the backlight assembly is mainly arranged to provide a uniform light source with good brightness for the display device. The backlight assembly generally includes a light source, a light guide sheet, a reflection sheet, and an optical diaphragm, and the reflection sheet may be a reflection coating coated on the surface of the light guide plate. The light guide sheet can convert the light source from a point light source to a uniform surface light source, and the arrangement of the reflection sheet can prevent light incident on the light guide plate from being emitted from the side away from the exit surface and can reflect back the light into the light guide plate, thus preventing the waste of light energy and effectively improving the utilization rate of light. The backlight provided by the backlight assembly can enable the display device to obtain a better display effect.

The foregoing description merely depicts some embodiments of the present application and therefore is not intended to limit the scope of the application. An equivalent structural or flow changes made by using the content of the specification and drawings of the present application, or any direct or indirect applications of the disclosure on any other related fields shall all fall in the scope of the application.

What is claimed is:

1. An array substrate, comprising:
a substrate;
a plurality of scan lines and data lines, covering the substrate, the scan lines and data lines crossing with each other to form a plurality of pixel regions, each pixel region defining a switch member electrically connected with the data line and scan line;
a first insulating layer, covering the scan line, the data line, and the switch member;
a pixel electrode, covering the first insulating layer and electrically connecting to the switch member, the pixel electrode comprising a plurality of branches arranged in parallel and spaced from each other, an angle being defined between the branch and the scan line, or between the branch and the data line;
a second insulating layer, covering the pixel electrode; and
at least one auxiliary electrode, defined on the second insulating layer and electrically contacted with the pixel electrode.

2. The array substrate according to claim 1, wherein the auxiliary electrode comprises a power receiving part and a reinforcing part connected to the power receiving part, the reinforcing part attaches to a surface of the second insulating layer, the second insulating layer defines a through hole, and the power receiving part extends into the through hole and connects to the pixel electrode.

3. The array substrate according to claim 2, wherein the middle portion of the reinforcing part bends downwards to form the power receiving part, and the power receiving part comprises a contact surface abutting the pixel electrode.

4. The array substrate according to claim 2, wherein one end of the reinforcing part bends to form the power receiving part.

5. The array substrate according to claim 1, wherein there are a plurality of auxiliary electrodes, the plurality of auxiliary electrodes are arranged in array and spaced from each other.

6. The array substrate according to claim 5, wherein the quantity of the auxiliary electrodes ranges from 3 to 20.

7. The array substrate according to claim 1, wherein the shape of a projection of the auxiliary electrode on the second insulating layer is rectangle, foursquare, or circle.

8. The array substrate according to claim 1, wherein the pixel electrode comprises a main body, and the branch connects to the periphery of the main body.

9. The array substrate according to claim 8, wherein the main body has a cross shape, and the plurality of branches are radially arranged around the center of the main body.

10. The array substrate according to claim 8, wherein the pixel electrodes are an integrated structure.

11. The array substrate according to claim 8, wherein an angle between the branch and the main body is 45 degrees.

12. The array substrate according to claim 8, wherein the main body is cross-shaped and divided into four regions which comprise an upper region, a lower region, a left region, and a right region, the plurality of branches are respectively arranged in a 45-degree direction with respect to a circumference of the main body in the four regions, and the branches in the adjacent two regions are mirrored.

13. The array substrate according to claim 1, wherein there are a plurality of auxiliary electrodes, the plurality of auxiliary electrodes are defined in parallel and spaced from each other, the shape of a projection of the auxiliary electrode on the second insulating layer is rectangle, the pixel electrode comprises a main body, and the branches connect to the periphery of the main body.

14. The array substrate according to claim 2, wherein there are a plurality of auxiliary electrodes, the plurality of auxiliary electrodes are in parallel and spaced from each other.

15. The array substrate according to claim 1, wherein the auxiliary electrode is indium antimony oxide.

16. An array substrate comprising:
a substrate;
a plurality of scan lines and data lines, covering the substrate, the scan lines and data lines crossing with each other to form a plurality of pixel regions, each pixel region defining a switch member electrically connected with the data line and scan line;
a first insulating layer, covering the scan line, the data line, and the switch member;
a pixel electrode, covering the first insulating layer and electrically connecting to the switch member, the pixel electrode comprising a plurality of branches arranged in parallel and spaced from each other, an angle being defined between the branch and the scan line, or between the branch and the data line, the pixel electrode comprising a main body, the branch connecting to the periphery of the main body, an angle defined between the branch and the main body being 45 degrees;
a second insulating layer, covering the pixel electrode; and
a plurality of auxiliary electrodes, defined on the second insulating layer and electrically contacted with the pixel electrode, the shape of a projection of the auxiliary electrode on the second insulating layer being rectangle, foursquare, or circle.

17. A display device, comprising a display panel and a backlight assembly connected to the display panel, the display panel comprising an array substrate and a color substrate facing the array substrate, the array substrate comprising:
a substrate;
a plurality of scan lines and data lines, covering the substrate, the scan lines and data lines crossing with each other to form a plurality of pixel regions, each pixel region defining a switch member electrically connected with the data line and scan line;
a first insulating layer, covering the scan line, the data line, and the switch member;
a pixel electrode, covering the first insulating layer and electrically connecting to the switch member, the pixel electrode comprising a plurality of branches arranged in parallel and spaced from each other, an angle being defined between the branch and the scan line, or between the branch and the data line;
a second insulating layer, covering the pixel electrode; and
at least one auxiliary electrode, defined on the second insulating layer and electrically contacted with the pixel electrode.

18. The display device according to claim 17, wherein the display panel further comprises a liquid crystal layer sandwiched by the array substrate and the color substrate.

19. The display device according to claim 17, wherein the auxiliary electrode comprises a power receiving part and a reinforcing part connected to the power receiving part, the reinforcing part attaches to a surface of the second insulating layer, the second insulating layer defines a through hole, and the power receiving part extends into the through hole and connects to the pixel electrode.

20. The display device according to claim 19, wherein the middle portion of the reinforcing part bends downwards to form the power receiving part, and the power receiving part comprises a contact surface abutting the pixel electrode.
